(19) United States
(12) Patent Application Publication
(10) Pub. No.: US 2026/0332733 A1
(43) Pub. Date: Oct. 22, 2026

(54) CROSSTALK ANALYSIS SYSTEM FOR CALCULATING CROSSTALK INDEX, METHOD FOR DRIVING THE SAME, AND ELECTRONIC DEVICE STORING CROSSTALK INDEX

(71) Applicant: SAMSUNG DISPLAY CO., LTD., YONGIN-SI (KR)

(72) Inventor: Young Sang HA, Yongin-si (KR)

(21) Appl. No.: 19/577,446

(22) Filed: Mar. 25, 2026

(30) Foreign Application Priority Data
Apr. 21, 2025 (KR) 10-2025-0051771

(51) Int. Cl. H04N 13/125; G02B 30/26

(52) U.S. Cl. CPC H04N 13/125; G02B 30/26

(57) ABSTRACT

Embodiments of the disclosure provide a crosstalk analysis system including a display device comprising a display panel on which a plurality of pixels to display an image are disposed, and a lens array disposed on the display panel, a camera configured to generate an evaluation image by capturing an image displayed on the display device, and a crosstalk analysis device including a crosstalk analysis module, a memory into which the crosstalk analysis module is loaded, and a processor to calculate and store a crosstalk index from the evaluation image by executing the crosstalk analysis module. According to embodiments of the disclosure, the crosstalk analysis system and methods of driving the system may facilitate the calculation of a crosstalk index.

### CROSS-REFERENCE TO RELATED APPLICATIONS

This application claims priority under 35 U.S.C §119 to and benefits from Korean Patent Application No. 10-2025-0051771 filed on Apr. 21, 2025 in the Korean Intellectual Property Office, the entire disclosure of which is herein incorporated by reference.

### TECHNICAL FIELD

Embodiments of the disclosure relate to a crosstalk analysis system for calculating a crosstalk index, a method for driving the same, and an electronic device storing the crosstalk index.

### DISCUSSION OF RELATED ART

With the development of information technology, the importance of display devices as a medium of connection between users and information has become increasingly important. In response to this, the use of display devices such as liquid crystal display devices and organic light emitting display devices is increasing.

A display device may stimulate the viewer's visual senses the same as (or similar to) a real-world object to provide a three-dimensional experience to the user of the display device. An image that may provide a three-dimensional experience to a user may be referred to as a stereoscopic image (3D image).

The display device uses various optical structures to trick the human visual system into perceiving depth from an image produced by a relatively flat surface. For example, the display device may provide different images to the left and right eyes of the user of the display device. The user may perceive the image as three-dimensional due to binocular parallax between the left and right eyes of the user.

Recently, there has been a lot of research on how users may view stereoscopic images without wearing stereoscopic glasses (also known as glasses-free methods or autostereoscopic). There are two types of glasses-free methods, lenticular, which uses a cylindrical array of lenses to separate the left and right eye images, and barrier (or ‘parallax barrier’), which uses a barrier to separate the left and right eye images.

The user perceives the combination of images displayed in both eyes to create a sense of depth. In lenticular display devices, if the alignment between the display panel and the lens array is insufficient, the user may see a leaky image. This leaky image may prevent the user from experiencing the depth of the image, or it may impair visibility in such a way that the image appears blurry. The phenomenon of leaky images being visible may be referred to as crosstalk.

### SUMMARY

Embodiments of the disclosure provide a crosstalk analysis system and a method for driving the system that quantifies the crosstalk phenomenon by calculating a crosstalk index.

Embodiments of the disclosure also provide an electronic device that stores the crosstalk index, which may improve the visibility of stereoscopic images.

Embodiments of the disclosure provides a crosstalk analysis system including a display device including a display panel on which a plurality of pixels to display an image are disposed, and a lens array disposed on the display panel. The crosstalk analysis system also includes a camera configured to generate an evaluation image by capturing an image displayed on the display device. A crosstalk analysis device including a memory into which a crosstalk analysis module is loaded and a processor to execute the crosstalk analysis module to calculate and store a crosstalk index from the evaluation image is also included in the crosstalk analysis system.

The crosstalk analysis device may be configured to calculate a center distance from the evaluation image, the center distance is a distance between a center of a reference image and a center of a leaked image.

The crosstalk analysis device may be configured to convert the calculated center distance into the crosstalk index for the display device.

A larger center distance corresponds to a larger crosstalk index.

The crosstalk analysis device may be configured to compare the evaluation image to a plurality of reference images and select one of the plurality of reference images that is most similar to the evaluation image.

The crosstalk analysis device may be configured to store the selected one of the plurality of reference images as most being similar to the evaluation image and a corresponding crosstalk index.

The crosstalk analysis device may be further configured to store a value of human visual acuity corresponding to the crosstalk index.

The display device may be configured to display a corrected image based on the calculated crosstalk index.

Embodiments of the disclosure may provide a method of driving a crosstalk analysis system comprising displaying a stereoscopic image on a display device that includes a left eye image and a right eye image, generating an evaluation image by a camera by capturing an image that is displayed on the display device, receiving the generated evaluation image by the crosstalk analysis device, calculating a crosstalk index based on a received evaluation image, and storing a calculated crosstalk index of the display device.

The calculating of the crosstalk index based on the received evaluation image, and the storing of the calculated crosstalk index as the crosstalk index of the display device may include calculating a center distance from the received evaluation index, the center distance is a distance between a center of a reference image and a center of a leaked image, the evaluation image may include the reference image and the leaked image, and storing the center distance as the crosstalk index of the display device.

The calculating of the crosstalk index based on the received evaluation image, and the storing of the calculated crosstalk index of the display device may include selecting one of a plurality of reference images most similar to the evaluation image by comparing the plurality of stored reference images with the received evaluation image, and storing the crosstalk index of the display device, the stored crosstalk image corresponding to the one of the plurality of reference images most similar to the evaluation image.

The storing of the crosstalk index corresponding to the reference image most similar to the evaluation image may further include storing a value of human visual acuity corresponding to the reference image most similar to the evaluation image.

Embodiments of the disclosure may provide an electronic device that includes a display device that includes a display panel on which a plurality of pixels for displaying an image are disposed, and a lens array disposed on the display panel,. The electronic device also includes a memory where a crosstalk index is stored, and a processor providing corrected image data to the display device by referring to the crosstalk index. The crosstalk index is calculated based on an evaluation image generated by capturing an image displayed on the display device.

The crosstalk index may be calculated by reference to a center distance, and the center distance may be a distance between a center of a reference image and a center of a leaked image in the evaluation image.

The crosstalk index may be calculated by selecting one of a plurality of reference images that is most similar to the evaluation image.

### BRIEF DESCRIPTION OF THE DRAWINGS

The above and other features of the disclosure will become more apparent by describing in further detail embodiments thereof with reference to the accompanying drawings, in which:

FIG. 1 is a drawing illustrating a lens array type display device;

FIG. 2 is a diagram illustrating a display device according to embodiments of the disclosure;

FIG. 3 is a diagram outlining the relationship between a depth score and a crosstalk index;

FIG. 4 is a diagram illustrating a crosstalk analysis system according to embodiments of the disclosure;

FIG. 5 is a block diagram of a computer device according to an embodiment of the disclosure.

FIG. 6 is a block diagram of a crosstalk analysis device according to an embodiment of the disclosure;

FIGS. 7A, 7B, and 7C, are illustrations of evaluation images according to an embodiment of the disclosure;

FIG. 8 is a flowchart illustrating a method for driving a crosstalk analysis system associated with the evaluation images of FIGS. 7A to 7C according to an embodiment of the disclosure;

FIG. 9 is an example diagram of the relationship between the reference image, human visual acuity, and crosstalk index;

FIG. 10 is an example drawing of an evaluation image according to an embodiment of the disclosure;

FIG. 11 is a flowchart illustrating a method for driving a crosstalk analysis system associated with the evaluation image of FIG. 10 according to an embodiment of the disclosure;

FIG. 12 is a block diagram of an electronic device according to an embodiment of the disclosure; and

FIG. 13 is a diagram of an electronic device according to various embodiments.

### DETAILED DESCRIPTION OF THE EMBODIMENTS

Hereinafter, with reference to the accompanying drawings, various embodiments of the disclosure will be described in detail to facilitate practice by one having ordinary skill in the art to which the embodiments belongs. The embodiments may be implemented in many different forms and is not necessarily limited to the embodiments described herein.

To clearly illustrate the disclosure, portions not pertinent to the description have been omitted, and identical or similar components have been designated by the same reference numerals throughout the specification. Accordingly, the aforementioned reference numerals may be used in other drawings.

Also, when "identical" is used in the description, it may mean "substantially identical," i.e., identical to the extent that a person of ordinary skill would be led to believe that they are identical. Other expressions may also omit "substantially".

Terms such as "first", "second" and the like may be used to describe various components, but the components are not to be limited by such terms. These terms are used only for the purpose of distinguishing a component from another. For example, a first component may be named a second component, and similarly, a second component may be named a first component, without departing from the scope of the disclosure. The singular expression includes the plural unless the context clearly indicates otherwise.

The terms "below", "under", "on", "above" and the like are used to describe the relationship of the configurations shown in the drawings. These terms are relative and are described with reference to the direction shown in the drawings.

The terms "comprising" or "having" and the like are intended to designate the presence of the features, numbers, steps, actions, components, parts, or combinations thereof described in the specification and are not to be understood as precluding the possibility of the presence or addition of one or more other features, numbers, steps, actions, components, parts, or combinations thereof.

While each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

Embodiments of the disclosure pertain to a crosstalk analysis system, an electronic device that includes the same, and a method of driving the crosstalk analysis system that quantifies the quality of stereoscopic images displayed on a display device and improves the quality of the images displayed. A camera captures an evaluation image that is a stereoscopic image displayed on a display device, determines therefrom a crosstalk index which corresponds to the quality of the stereoscopic image, and may attempt to correct the image. The crosstalk index can be derived by either determining a center distance that is a distance between a center of a reference image and a center of a leaked image that constitute the evaluation image, or by comparing the captured evaluation image with a plurality of stored reference images and selecting one of the stored reference images most like the evaluation image. By determining the crosstalk index, the quality of the stereoscopic image can be quantified, and the visibility of stereoscopic images displayed can be improved.

Embodiments of the disclosure will now be described in detail with reference to the accompanying drawings.

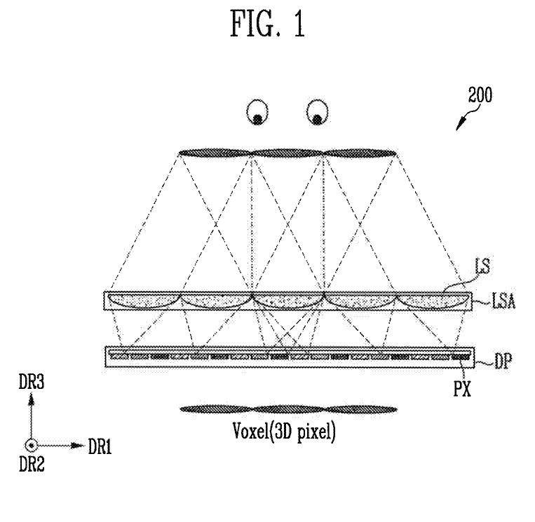

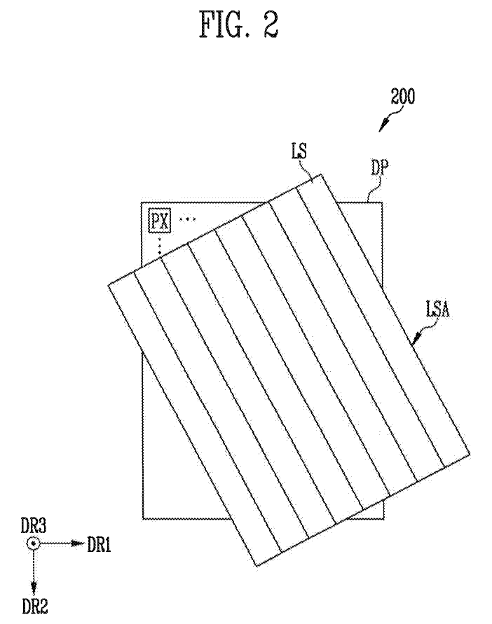

FIG. 1 is a drawing to illustrate a lens array type display device 200. FIG. 2 is a diagram illustrating the display device 200 according to embodiments of the disclosure.

Referring to FIGS. 1 and 2, the display device 200 may include a display panel DP and a lens array LSA. For example, the display device 200 may be a stereoscopic image display device that displays a stereoscopic image (or 3D image). The display panel DP and the lens array LSA may be stacked on each other and positioned in an upward and downward direction (e.g., a third direction DR3).

The display panel DP may include pixels PX that emit light to display an image. In an embodiment, each of the pixels PX may output one of red light, green light, and blue light. However, this is exemplary, and the colors of the light emitted by the pixels PX are not necessarily limited to these, and various colors of light may be output for a full-color implementation.

In an embodiment, the display panel DP may be coupled to a drive circuit that drives the pixels PX. The drive circuit may perform at least one of the functions of a gate drive, a data drive, and a drive control. For example, the drive circuit may be coupled to the display panel DP and may be located on a back surface of the display panel DP. For example, at least a portion of the drive circuit may be formed directly on the display panel DP, or may be disposed on the front of the display panel DP.

In an embodiment, the pixels PX may be disposed on the front of the display panel DP to form a light emitting surface. An image may be displayed through the pixels PX. The display panel DP may include multiple rows of pixels and multiple columns of pixels. Here, a row of pixels may refer to a group of pixels each connected to a same gate line, and a column of pixels may refer to a group of pixels each connected to a same data line. For example, the pixel rows may be arranged in a first direction DR1 and the pixel columns may be arranged in a second direction DR2.

In an embodiment, the display panel DP may include a pixel circuit layer and a display element layer disposed on a substrate (e.g., predetermined or selectable substrate) to form a pixel PX. The display panel DP may further include an envelope structure such as a housing or a bezel that encloses the display element layer. In an embodiment, the display panel DP may further include a polarization layer. The polarization layer may include a phase retarder and/or a polarizer. The polarization layer may be located on the light emitting elements, but embodiments of the disclosure are not necessarily limited thereto. For example, the polarization layer may be located on an exterior of the display panel DP.

The pixel circuit layer may include a pixel circuit configured to drive light emitting elements of the pixel PX. For example, the pixel circuit layer may include transistors, signal lines connected to the transistors, and power lines. The pixel circuit layer may have a stacked structure for forming the transistors.

The display element layer may be disposed on the pixel circuit layer. The display element layer may include light emitting elements. The light emitting elements may be electrically connected to the pixel circuits of the pixel circuit layer. In an embodiment, the light emitting elements may be spontaneous light emitting elements. The spontaneous light emitting element may include an organic light emitting element, an inorganic light emitting element, or a light emitting element composed of a combination of an inorganic material and an organic material. In the above embodiment, the display panel DP may be a spontaneous light display panel. However, this is exemplary, and the light-emitting element may also include a light-emitting element that emits by changing the wavelength of the light emitted using quantum dots (quantum dot display element).

The display panel DP may also be implemented as a liquid crystal display panel, a plasma display panel, a display panel that utilizes quantum dots to display images, and the like.

The lens array LSA may comprise lenses LS disposed on the display panel DP to refract light incident from the pixels PX. For example, the lens array LSA may be implemented as a lenticular lens array, a micro lens array, or the like.

A light field display may be a three-dimensional (3D) display that utilizes a flat display and optical elements (e.g., lens arrays LSA) to form a light field represented by the vector distribution (intensity, direction) of light in space to create a stereoscopic image. The light field display is a display technology that is expected to be utilized in various ways by converging with virtual reality (VR), augmented reality (AR), mixed reality (MR), and extended reality (XR) technologies. The light field display may enable the realization of more natural three-dimensional images by allowing users to see depth and sides of objects.

Light fields may be implemented in a variety of ways. For example, a light field may be formed by using multiple projectors to create a light field having multiple directions, by using a diffraction grating to control the direction of light, by using two or more panels to control the direction and intensity of light for each combination of pixels, by using pinholes or barriers to control the direction of light, by using a lens array to control the direction of light refraction, and so on.

In an embodiment, the lens array type display device 200 as shown in FIG. 1 may display a three-dimensional image (3D image) by forming a light field.

Each of the lenses LS is assigned a set of pixels PX, and the light from each pixel PX may be refracted by the lenses LS and directed in a specific direction to form a light field that is expressed in terms of light intensity and direction. When a viewer looks at the display device 200 in the light field thus formed, the viewer may perceive the image as three-dimensional.

Image information based on the viewer's perspective in a light field may be defined and processed in terms of voxels. A voxel may be understood as a piece of graphical information that defines a point (e.g., predetermined or selectable point or pixel) in three-dimensional space.

In an embodiment, the lens array LSA may include a lenses LS having a semi-cylindrical shape extending in a direction. Such lenses LS may be implemented, for example, as lenticular lenses. For example, as shown in FIG. 2, the lenses LS may extend at an angle with respect to each of the first direction DR1 and the second direction DR2 (also referred to as a slanted arrangement). However, this is an example and the direction of extension (and arrangement) of the lenses LS and the embodiment of the disclosure is not necessarily limited thereto.

The size and placement of the lenses LS may be determined by conditions such as the size of the display panel DP, the viewing distance of the user, the size, resolution, and pixel arrangement structure of the pixels PX.

In an embodiment, the lenses LS may be implemented as a micro lens. When viewed in a plan view, the micro lens may have a hexagonal, circular, oval, or other shape.

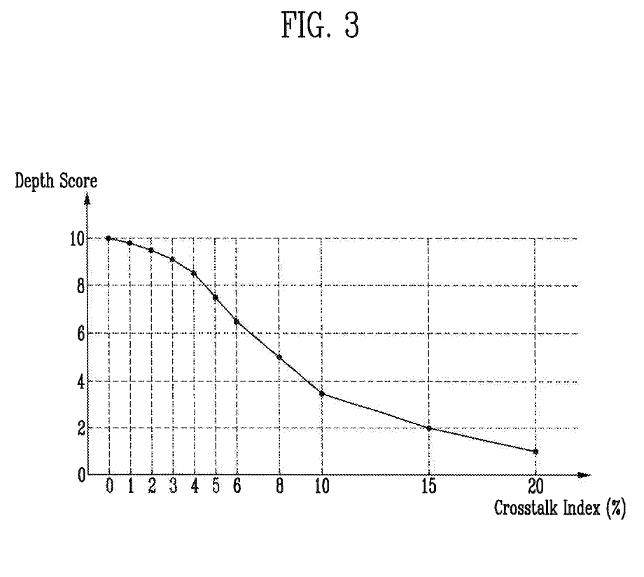

FIG. 3 is a diagram that outlines the relationship between depth score and crosstalk index.

The depth score is a subjective measure of how much the user perceives a sense of depth. For example, the depth score may be measured on a 10-point scale. In the above embodiment, a depth score of 10may indicate that the user naturally perceives a sense of depth in an image. A depth score of 1may indicate that the user does not perceive a sense of depth in an image.

The crosstalk index may be defined as a ratio (e.g., percentage (%)). In an embodiment, the crosstalk index may be defined as a ratio between a luminance of the leaked image and a luminance of the normal (or reference) image.

Referring further to FIGS. 1 and 2 above, the crosstalk index may be greater in a display device where the display panel DP and the lens array LSA are not properly aligned with each other. In a display device where the display panel DP and lens array LSA are properly aligned with each other, the crosstalk index may be smaller.

Referring to FIG. 3, as the crosstalk index increases, the depth score decreases, as does the user's perception of stereoscopic depth.

Meanwhile, a simpler method for measuring the crosstalk index is proposed, such as a method for measuring the crosstalk index without having to display the image multiple times on the display device to measure the luminance of a leaky image and the luminance of a normal image, respectively.

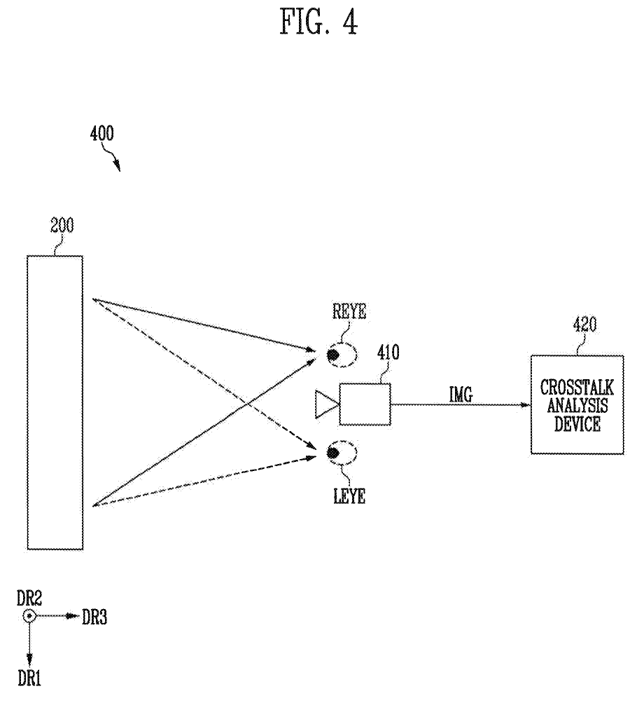

FIG. 4 is a diagram illustrating a crosstalk analysis system 400 according to embodiments of the disclosure.

Referring to FIG. 4, a crosstalk analysis system 400 according to embodiments of the disclosure may include the display device 200, a camera 410, and a crosstalk analysis device 420.

The display device 200 may display a stereoscopic image by providing an image to the user's left eye LEYE and right eye REYE, respectively.

The camera 410 may capture (or take) the image of what is being displayed on the display device 200 and generate an evaluation image IMG based on the captured image.

The crosstalk analysis device 420 may receive the captured evaluation image IMG from the camera 410. The crosstalk analysis device 420 may calculate a crosstalk index of the display device 200 based on the captured evaluation image IMG.

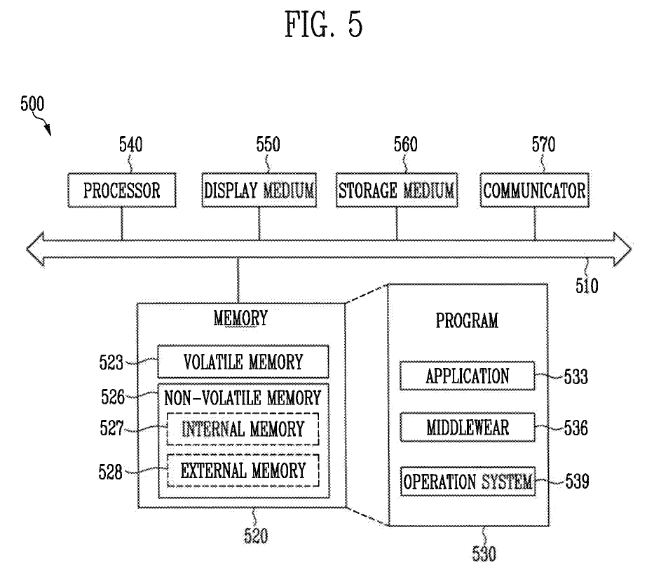

FIG. 5 is a block diagram of a computer device 500, according to an embodiment of the disclosure.

The computer device 500 (or computer program product) according to embodiments of the disclosure may include a bus 510, a memory 520, a processor 540, a display medium 550, a storage medium 560, and a communicator 570 (e.g., a transceiver radio assembly or a wireline connection).

The bus 510 may be connected to various components of the computer device 500 to carry data, signals, and information. The processor 540 may be either a general purpose or a dedicated processor and may control various operations of the computer device 500. At least some of the components of the bus 510 may function as interfaces.

The display medium 550 may visually present information to an exterior of the computer device 500 (e.g., a user of the computer device 500). The display medium 550 may include, for example, a display panel, a drive circuit, or the like.

The processor 540 may execute software (e.g., the program 530) to control at least one other component (e.g., a hardware or software component) of the computer device 500 connected to the processor 540, and may perform various data processing tasks or computations. According to embodiments of the disclosure, as at least part of the data processing or computation, the processor 540 may store data received from other components (e.g., camera, communicator 570, etc.) in a volatile memory 523, process instructions or data stored in the volatile memory 523, and store the resulting data in a non-volatile memory 526. The processor 540 may include a main processor (e.g., a central processing unit (CPU)), an application processor (AP)) or auxiliary processors (or co-processors such as a graphics processing unit (GPU), neural processing unit (NPU), image signal processor, sensor hub processor, communications processor, etc.) that may operate independently or in conjunction therewith. For example, in an embodiment where the computer device 500 includes a main processor and a co-processor, the co-processor may be configured to use less power than the main processor, or to specialize in a given function. The co-processor may be implemented independently of, or as part of, the main processor.

The co-processor may control at least some of the functions or states associated with at least one component (e.g., the display medium 550) of the components of the computer device 500, for example, on behalf of the main processor while the main processor is in an inactive (e.g., sleeping) state, or in conjunction with the main processor while the main processor is in an active (e.g., running an application) state. According to embodiments of the disclosure, a co-processor (e.g., image signal processor or communication processor) may be implemented as part of another functionally related component (e.g., camera, communicator 570, etc.). In accordance with embodiments, the co-processor (e.g., neural network processing unit) may include hardware structures specialized for processing artificial intelligence models. The artificial intelligence model may be generated via machine learning.

The memory 520 may store various data used by at least one component of the computer device 500 (e.g., the processor 540). The data may include, for example, input data or output data for software (e.g., program 530) and instructions associated therewith. The memory 520 may include the volatile memory 523 and the non-volatile memory 526. The non-volatile memory 526 may include an internal memory 527 (or an embedded memory). The non-volatile memory 526 may further include an external memory 528 (or a data storage device). The computer device 500 may be further coupled to a separate storage medium 560 via the bus 510.

The program 530 may be stored as software in the memory 520. The program 530, for example, may include an application 533, a middleware 536, an operating system 539, and the like.

The display medium 550 may be configured to visually present information to a user (or party) external to the computer device 500 (e.g., a user of the computer device 500). The display medium 550 may include, for example, a display, a holographic device, a projector, and a control circuit for controlling the device.

The communicator 570 may support establishing a direct (e.g., wired) or wireless communication channel between the computer device 500 and an external electronic device (e.g., server, terminal, etc.), and may conduct communications over the established communication channel. The communicator 570 may include one or more communications processors that operate independently of the processor 540 (e.g., application processor) and support direct or wireless communications. According to an embodiment, the communicator 570 may include at least one of a wireless communication module (e.g., a cellular communication module, a near field communication module, a global navigation satellite system (GNSS) communication module), and a wired communication module (e.g., a local area network (LAN) communication module, or a power line communication module). Any of these communication modules may communicate with an external electronic device via a first network or a second network. The first network may be a local area network. The local area network may include, for example, at least one of BLUETOOTH® (a short-range wireless communications protocol), wireless fidelity (WiFi®) Direct, and infrared data association (IrDA). The second network may be a telecommunications network. The telecommunications network for example may include at least one of a legacy cellular network, a fifth generation (5G) network, a next generation telecommunications network, the Internet, and a computer network (e.g., a local area network (LAN) or a wide area network (WAN)). These different types of communication modules may be integrated into a single component (e.g., a single chip), or may be implemented as multiple separate components (e.g., multiple chips). The wireless communication module may use subscriber information (e.g., an International Mobile Subscriber Identity (IMSI)) stored in the subscriber identification module to identify or authenticate the corresponding computer device 500 in a communication network, such as a first network or a second network.

The computer device 500 according to embodiments of the disclosure may further include a power management module configured to manage power supplied to the computer device 500. The power management module for example may be implemented as at least a portion of a power management integrated circuit (PMIC).

At least some of its components in the computer device 500 according to the disclosure may be connected to each other via peripheral communication methods (e.g., bus, general purpose input and output (GPIO), serial peripheral interface (SPI), or mobile industry processor interface (MIPI)) and may exchange signals (e.g., commands or data, etc.) with each other.

In an embodiment, the computer device 500 may be implemented as at least one of the display device 200, the camera 410, and the crosstalk analysis device 420 of FIG. 4.

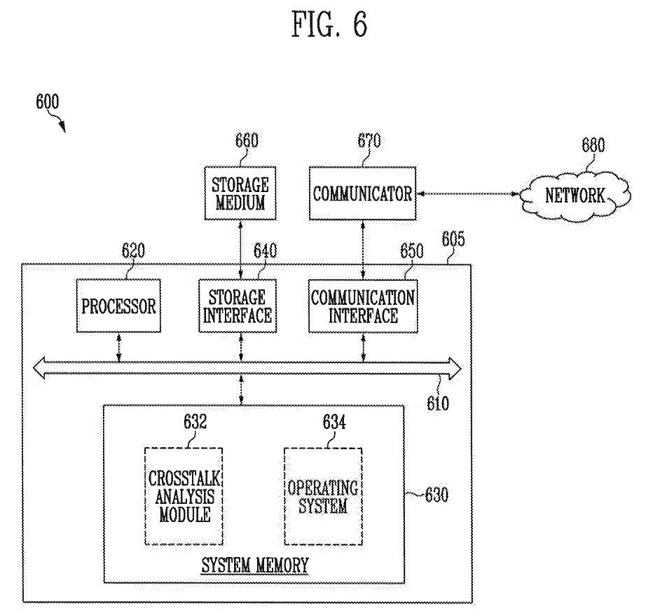

FIG. 6 is a block diagram of a crosstalk analysis device 420 (see FIG. 4) according to an embodiment.

The crosstalk analysis device 420 of FIG. 4 may be implemented as the computer device 600 of FIG. 6.

Referring to FIG. 6, the computer device 600 may include a bus 610, a processor 620, a system memory 630, a storage interface 640, a storage medium 660, a communication interface 650, a communicator 670, and the like.

The bus 610 may be connected to various components of the computer device 600 to carry data, signals, and information.

The processor 620 may be either a general purpose or a dedicated processor, and may control various operations of the computer device 600. The processor 620 may be configured to load program code and instructions into the system memory 630 that, when executed, provide various functions and processes the loaded program code and instructions. The system memory 630 may be provided as working memory and/or buffer memory of the processor 620. As an embodiment, the system memory 630 may include at least one of a random access memory (RAM), a read only memory (ROM), and other types of computer-readable media.

The processor 620 may load a crosstalk analysis module 632 and the like into the system memory 630 when executed by the processor 620. Such program code and/or instructions may be executed by the processor 620 to perform crosstalk analysis functions and/or operations. The program code and/or instructions may be loaded into the system memory 630 from the storage medium 660 which is a separate computer-readable recording medium. As another example, the program code and/or instructions may be loaded into the system memory 630 via the communicator 670 from an exterior of the computer device 600.

Further, the processor 620 may load an operating system 634 into the system memory 630 to provide a suitable environment for the crosstalk analysis module 632 to run when executed by the processor 620, and may execute the loaded operating system 634. The operating system 634 may interface between the crosstalk analysis module 632 and the storage interface 640, communication interface 650, etc. of the computer device 600. In embodiments, at least some of the functions of the storage interface 640, communication interface 650, etc. may be performed by the operating system 634.

In FIG. 6, the system memory 630 is shown in a separate configuration from the processor 620, but at least a portion of the system memory 630 may be included in the processor 620. According to embodiments, the system memory 630 may be provided as multiple memories that are physically and/or logically isolated from each other according to embodiments.

The storage interface 640 may be connected to the storage medium 660. The storage interface 640 may interface between components such as the processor 620 and the system memory 630 connected to the bus 610 and the storage medium 660. The communication interface 650 is connected to the communicator 670. The communication interface 650 may interface between components connected to the bus 610 and the communicator 670.

The storage medium 660 may include various types of non-volatile storage media that retain stored data even when power is lost, such as flash memory, hard disks, and the like.

The communicator 670 (or ‘transceiver’) may transmit and receive signals between the computer device 600 and other electronic devices on the network 680 (e.g., the camera 410 of FIG. 4).

The bus 610, the processor 620, the system memory 630, the storage interface 640, and the communication interface 650 may be disposed on a board 605.

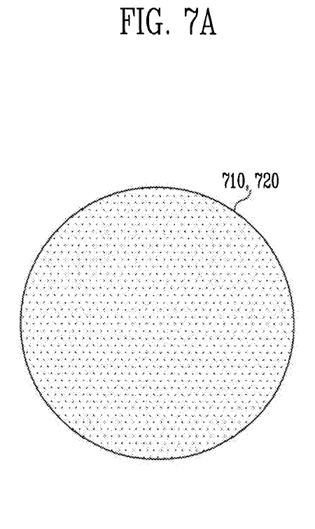

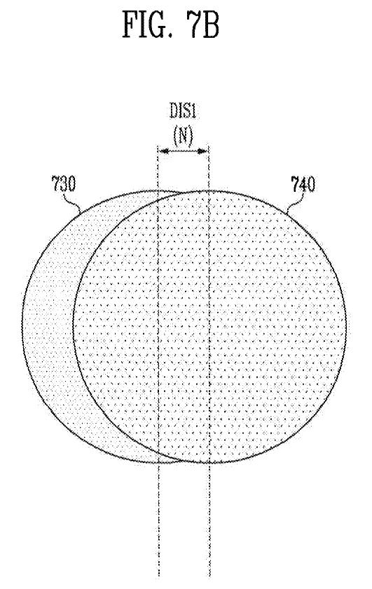

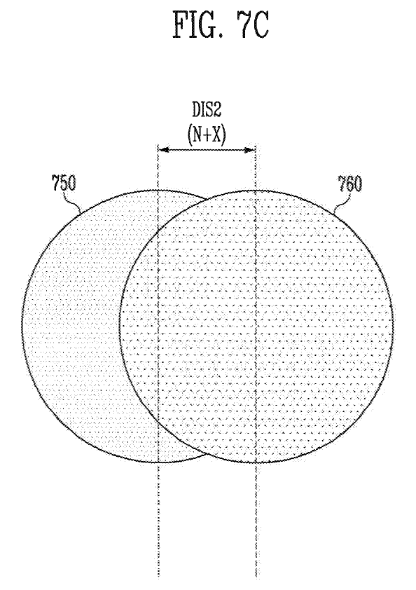

FIGS. 7A, 7B, and 7C are illustrations of exemplary evaluation images IMG (see FIG. 4) according to an embodiment of the disclosure.

The evaluation images may include a baseline (or reference) image and a leakage image.

Referring to FIG. 7A, a reference image 720 is shown, and the leaked image 710 may fully overlap the reference image 720 in the evaluation image. The leaked image 710 may be substantially invisible to the user of the display device 200 (see FIG. 2), which allows the user to experience a natural sense of three-dimensionality.

Referring to FIG. 7B, a reference image 740 is shown, and the leaked image 730 may be visible in the evaluation image at a distance (e.g., predetermined or selectable distance) from the reference image 740. In the above case, the user of the display device 200 (see FIG. 2) may see a portion of the leaked image 730 which may give the user a lesser sense of natural depth.

A distance (e.g., predetermined or selectable distance) between the reference image 740 and the leaked image 730 may be defined as a distance between a center of the reference image 740 and a center of the leaked image 730. Referring to FIG. 7B, the first distance DIS1, which is the distance between the center of the reference image 740 and the center of the leaked image 730, is shown as "N" where N may be a positive number.

In embodiments of the disclosure, the crosstalk index may correspond to a distance between the center of the reference image and the center of the leaked image. For example, a crosstalk index of 0 % in FIG. 4 may correspond to a distance of 0 mm between the center of the reference image and the center of the leaked image. As another example, a crosstalk index of n % greater than 0 in FIG. 4 may correspond to a distance of N mm between the center of the reference image and the center of the leaked image.

Referring to FIG. 7C, a reference image 760 is shown, and the leaked image 750 may be visible at a distance (e.g., predetermined or selectable distance) from the reference image 760 in the evaluation image. A user of the display device 200 (see FIG. 2) may see a substantial portion of the leaked image 750, which may result in the user having a low sense of three-dimensionality.

Referring to FIG. 7C, the second distance DIS2 which is the distance between the center of the reference image 760 and the center of the leaked image 750 is shown as "N+X", where N and X may each be a positive real number. The case where the crosstalk index of FIG. 4 is m % greater than 0 may correspond to a case where the distance between the center of the reference image and the center of the leaked image is (N+X) mm.

Referring to FIGS. 7A to 7C, the distance between the centers of the leaked images 710, 730, 750 and the centers of the reference images 720, 740, 760, respectively, may be measured, and the distance between the measured centers may be used to determine a crosstalk index by a correspondence between the distance between the measured centers and the crosstalk index.

Accordingly, a crosstalk index may be obtained by displaying an image on the display device 200 (see FIG. 2), and calculating the distance between the centers of the reference image and the leaked image in the evaluation image obtained from the captured, displayed image. By doing so, it is possible to efficiently determine whether the display panel DP (see FIG. 1) and the lens array LSA (see FIG. 1) are properly aligned.

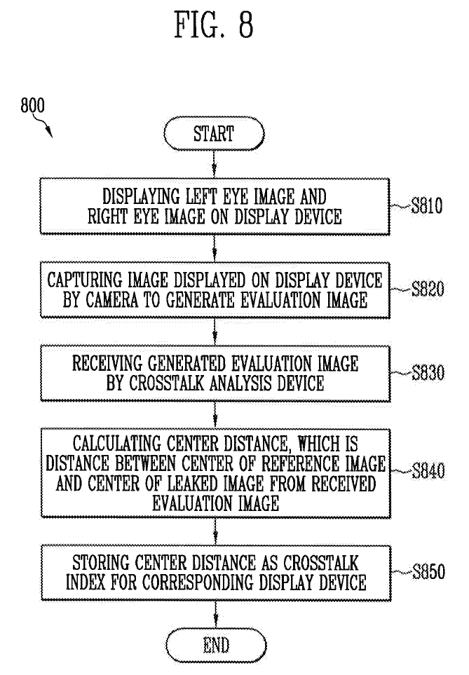

FIG. 8 is a flowchart illustrating a method 800 for driving a crosstalk analysis system associated with the evaluation images of FIGS. 7A to 7C according to an embodiment of the disclosure.

At step S810, the display device may display the left eye image and the right eye image.

At step S820, the camera may capture an image displayed on the display device to generate an evaluation image. The camera and the display device may correspond to the camera 410 and the display device 200 described with reference to FIG. 4, respectively.

At step S830, the crosstalk analysis device may receive the generated evaluation image. The crosstalk analysis device may correspond to the crosstalk analysis device 420 described with reference to FIG. 4. The evaluation image may correspond to the evaluation image IMG described with reference to FIG. 4.

At step S840, a center distance may be calculated, where the center distance corresponds to a distance between the center of the reference image and the center of the leaked image. Step S840 may be performed by the crosstalk analysis device 420 (see FIG. 4). Referring further to FIG. 6, the processor 620 of the crosstalk analysis device 420 may execute the crosstalk analysis module 632 loaded in the system memory 630 to calculate the center distance, which is the distance between the center of the reference image and the center of the leakage image.

At step S850, the center distance may be stored as a crosstalk index for the corresponding display device. In other embodiments, the center distance may be converted to a corresponding crosstalk index and the crosstalk index corresponding to the center distance may be stored. Step S850 may be performed by the crosstalk analysis device 420 (see FIG. 4).

In the embodiment of FIGS. 7A to 8, a camera captures an evaluation image that is a stereoscopic image displayed on a display device, determines therefrom a crosstalk index from a center distance that is a distance between a center of a reference image and a center of a leaked image that constitute the evaluation image, and stores the crosstalk index for the display device. The crosstalk index may be sued to correct or improve upon stereoscopic image quality displayed by the display device.

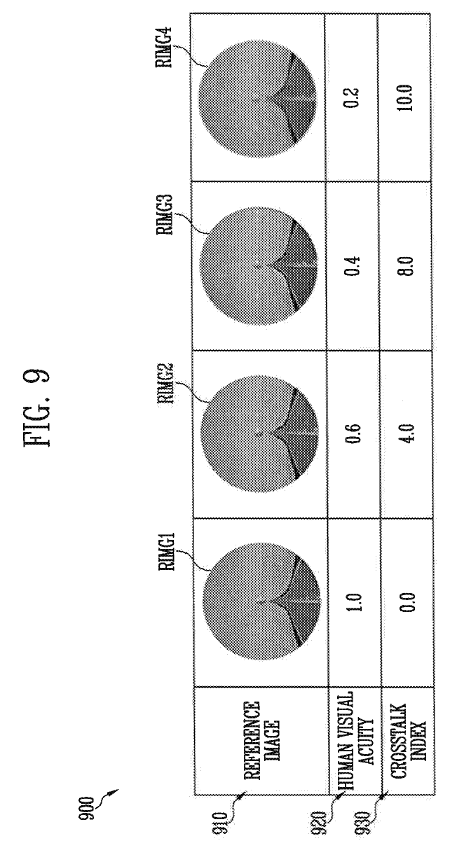

FIG. 9 is an example diagram 900 illustrating a relationship between a reference image, human visual acuity, and a crosstalk index.

Diagram 900 shows multiple reference images RIMG1 through RIMG4 corresponding to a reference image 910 entries, values corresponding to a human visual acuity 920, and a crosstalk index 930.

Each of the reference images RIMG1 through RIMG4 may be associated with a value of human visual acuity 920 and a value of the crosstalk index 930. In an embodiment, the reference images RIMG1 through RIMG4 may be images used to measure visual acuity (e.g., the refractive index of the retina) in a field related to human vision testing. Accordingly, by determining which of the reference images RIMG1 through RIMG4 most closely resembles the evaluation image based on the principle that the location of the phase shift depends on the refractive index, the degree of misalignment between the display panel DP (see FIG. 1) and the lens array LSA (see FIG. 1) may be calculated. The degree of misalignment between the display panel DP and the lens array LSA may be calculated as a crosstalk index.

For example, a first reference image RIMG1 may be the sharpest image among the reference images RIMG1 through RIMG4. A corresponding value of the human visual acuity 920 may be 1.0. The corresponding value of the crosstalk index 930 may be 0.0.

As another example, a second reference image RIMG2 may be the second sharpest image among the reference images RIMG1 through RIMG4. A corresponding value of the human visual acuity 920 may be 0.6. The corresponding value of the crosstalk index 930 may be 4.0.

As another example, a third reference image RIMG3 may be the third sharpest image among the reference images RIMG1 through RIMG4. A corresponding value of the human visual acuity 920 may be 0.4. The corresponding value of the crosstalk index 930 may be 8.0.

As another example, a fourth reference image RIMG4 may be the fourth sharpest image among the reference images RIMG1 through RIMG4. A corresponding value of the human visual acuity 920 may be 0.2. The corresponding value of the crosstalk index 930 may be 10.0.

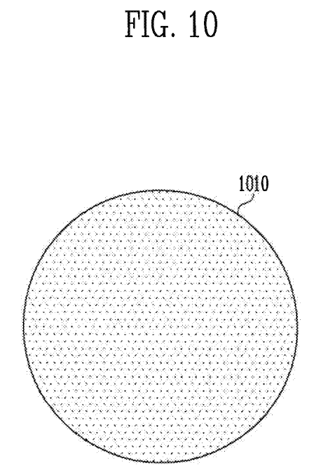

FIG. 10 is an example drawing of an evaluation image 1010 according to an embodiment of the disclosure.

In embodiments of the disclosure, the evaluation image 1010 may be compared to the aforementioned reference images RIMG1 to RIMG4 (see FIG. 9). As a result of the comparison, the most similar image among the reference images RIMG1 through RIMG4 may be selected, and the crosstalk index 930 (see FIG. 9) corresponding to the selected reference image may be stored as the crosstalk index of the corresponding display device.

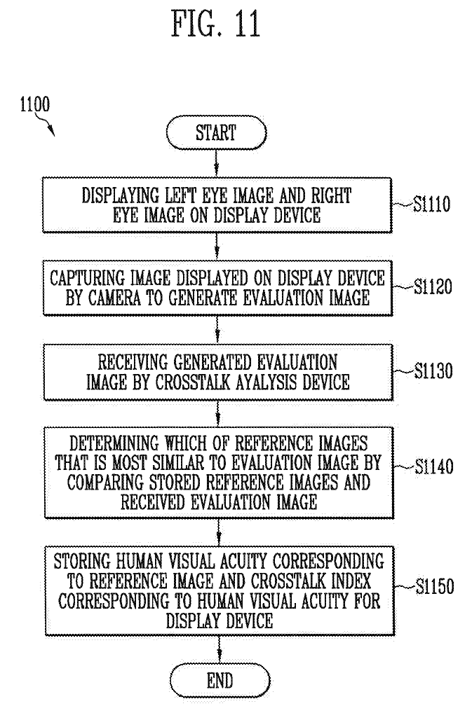

FIG. 11 is a flowchart illustrating a method 1100 for driving a crosstalk analysis system associated with the evaluation image of FIG. 10 according to an embodiment of the disclosure.

At step S1110, the display device may display the left eye image and the right eye image.

At step S1120, the camera may capture an image that is displayed on the display device to generate an evaluation image.

At step S1130, the crosstalk analysis device may receive the generated evaluation image.

At step S1140, stored reference images and the received evaluation image may be compared to determine which of the reference images is most similar to the evaluation image. Step S1140 may be performed by the crosstalk analysis device 420 (see FIG. 4). Referring further to FIG. 6, the processor 620 of the crosstalk analysis device 420 may execute the crosstalk analysis module 632 loaded in the system memory 630 to select the reference image that is most similar to the evaluation image.

At step S1150, the human visual acuity corresponding to the selected reference image and the crosstalk index corresponding to the human visual acuity may be stored for the corresponding display device. In an embodiment, the crosstalk analysis device 420 (see FIG. 4) might not store the value of the human visual acuity but only the corresponding crosstalk index for the corresponding display device.

In accordance with embodiments of the disclosure, a crosstalk index may be effectively evaluated and/or calculated.

In the embodiment of FIGS. 10 and 11, a camera captures an evaluation image that is a stereoscopic image displayed on a display device, determines therefrom a crosstalk index by comparing the evaluation image with a plurality of stored reference images, and selecting a one of the plurality of stored reference images most like the evaluation image. The crosstalk index for the display can then be determined from the selected reference image, and then the crosstalk index for the display device can be stored and also can be used to improve or correct the image quality.

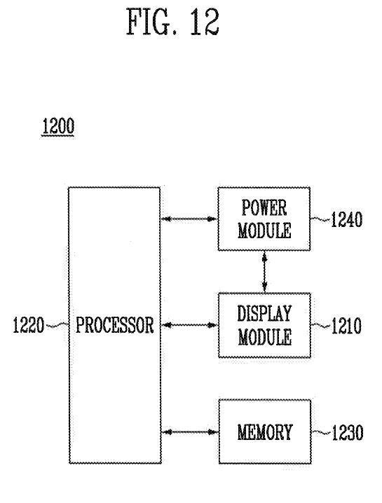

FIG. 12 is a block diagram of an electronic device 1200 according to an embodiment of the disclosure.

Referring to FIG. 12, the electronic device 1200 according to an embodiment may include a display module 1210, a processor 1220, a memory 1230, and a power module 1240.

The processor 1220 may include at least one of a central processing unit (CPU), an application processor (AP), a graphics processing unit (GPU), a communication processor (CP), an image signal processor (ISP), and a controller.

The memory 1230 may store data information required for operation of the processor 1220 or the display module 1210. When the processor 1220 executes an application stored in the memory 1230, image data signals and/or input control signals are provided to the display module 1210, and the display module 1210 may process the provided signals to output image information via a display screen.

The power module 1240 may include a power supply module such as a power adapter or battery member, and a power conversion module to generate the power required for operation of the electronic device 1200 by converting the power supplied by the power supply module.

At least one of each of the above-described modules of the electronic device 1200 may be included in the display device 200 (see FIG. 2) according to the above-described embodiments. As another example, some of the individual modules that are functionally included in the electronic device 1200 may be included in the display device 200 and others may be provided external to the display device 200. For example, the display device 200 may include the display module 1210, while the processor 1220, the memory 1230, while the power module 1240 may be provided in the electronic device 1200 that is external to the display device 200.

In an embodiment, the calculated crosstalk index may be stored in the memory 1230. In the above embodiment, the processor 1220 may provide calibrated image data to the display module 1210 (or the display device 200 (see FIG. 2)) by referencing the crosstalk index stored in the memory 1230. Accordingly, even if the alignment between the display panel DP (see FIG. 1) and the lens array LSA (see FIG. 1) is somewhat misaligned, the user may perceive a more natural three-dimensional appearance of the image.

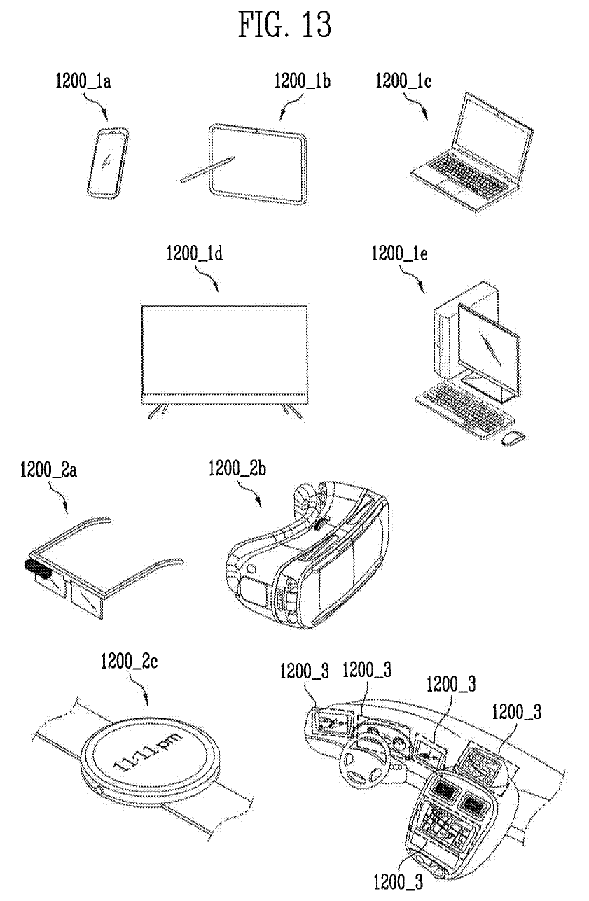

FIG. 13 is an illustration of an electronic device 1200 according to various embodiments.

Referring now to FIG. 13, various electronic devices with display devices according to embodiments may include electronic devices for displaying images, such as smartphones 1200_1a, tablets 1200_1b, laptops 1200_1c, televisions 1200_1d, computer monitors 1200_1e, as well as smart glasses 1200_2a, head-mounted displays 1200_2b, wearable electronic devices including display modules such as smart watches 1200_2c, head-mounted displays 1200_2b, wearable electronic devices that include display modules such as smart glasses 1200_2a, head-mounted displays 1200_2b, smart watches 1200_2c, and the like, and automotive electronic devices 1200_3 that include display modules such as center information displays (CIDs), room mirror displays, and the like disposed on the instrument panel, center fascia, or dashboard of an automobile.

According to embodiments of the disclosure, a crosstalk analysis system and methods of driving the system may facilitate the calculation of a crosstalk index.

According to an electronic device in which the crosstalk index is stored according to embodiments of the disclosure, the viewability of stereoscopic images may be improved.

The foregoing referenced drawings and detailed description of the embodiments are merely an example and are intended to illustrate the embodiments and are not intended to limit the meaning or to restrict the scope of the embodiments as claimed in the appended patent claims. Accordingly, one having ordinary knowledge in the art will understand that various modifications and other equally valid embodiments are possible therefrom. Accordingly, the true scope of technical protection of the embodiments should be determined by the technical ideas of the appended patent claims.

What is claimed is:

1. A crosstalk analysis system comprising:
a display device comprising:
a display panel on which a plurality of pixels to display an image are disposed; and
a lens array disposed on the display panel;
a camera configured to capture an evaluation image displayed on the display device; and
a crosstalk analysis device comprising:
a crosstalk analysis module;
a memory into which the crosstalk analysis module is loaded; and
a processor to calculate and store a crosstalk index from the evaluation image by executing the crosstalk analysis module.

2. The crosstalk analysis system of claim 1, wherein
the crosstalk analysis device is configured to calculate a center distance from the evaluation image,
the center distance is a distance between a center of a reference image and a center of a leaked image.

3. The crosstalk analysis system of claim 2, wherein the crosstalk analysis device is further configured to convert the calculated center distance into the crosstalk index for the display device.

4. The crosstalk analysis system of claim 2, wherein a larger center distance corresponds to a larger crosstalk index.

5. The crosstalk analysis system of claim 1, wherein the crosstalk analysis device is configured to compare the evaluation image to a plurality of reference images and select one of the plurality of reference images that is most similar to the evaluation image.

6. The crosstalk system of claim 5, wherein the crosstalk analysis device is further configured to store the selected one of the plurality of reference images selected as being most similar to the evaluation image.

7. The crosstalk analysis system of claim 6, wherein the crosstalk analysis device is further configured to calculate a human visual acuity value from the crosstalk index and store the calculated human visual acuity value.

8. The crosstalk analysis system of claim 1, wherein the display device is configured to display a corrected image based on the calculated crosstalk index.

9. The crosstalk analysis system of claim 1, wherein
the display device is configured to display an autostereoscopic image, and
the crosstalk index is a quantified value that corresponds to a degree of natural perception of three dimensionality perceived of a viewer.

10. The crosstalk analysis system of claim 2, wherein the evaluation image comprises:
the reference image; and
the leaked image.

11. A method of driving a crosstalk analysis system comprising:
displaying a stereoscopic image on a display device that includes a left eye image and a right eye;
generating an evaluation image by a camera by capturing the stereoscopic image displayed on the display device;
receiving the generated evaluation image by the crosstalk analysis device;
calculating a crosstalk index based on the received evaluation image; and
storing a calculated crosstalk index of the display device.

12. The method of claim 11, wherein the calculating of the crosstalk index based on the received evaluation image and the storing of the calculated crosstalk index of the display device comprises:
calculating a center distance from the received evaluation image, the center distance being a distance between a center of a reference image and a center of a leaked image, the evaluation image including the reference image and the leaked image, the leaked image being portions of the left eye image that has leaked into the right eye image and portions of the right eye image that has leaked into the left eye image; and
storing the center distance as the crosstalk index of the display device.

13. The method of claim 11, wherein the calculating of the crosstalk index based on the received evaluation image and the storing of the calculated crosstalk index of the display device comprises:
selecting one of a plurality of reference images most similar to the evaluation image by comparing the plurality of reference images with the received evaluation image; and
storing the crosstalk index of the display device, the stored crosstalk index corresponding to the one of the plurality of reference images that is most similar to the evaluation image.

14. The method of claim 13, wherein the storing of the crosstalk index corresponding to the reference image most similar to the evaluation image further comprises:
storing a value of human visual acuity corresponding to the reference image most similar to the evaluation image.

15. An electronic device comprising:
a display device comprising:
a display panel on which a plurality of pixels for displaying an image are disposed; and
a lens array disposed on the display panel;
a memory where a crosstalk index is stored; and
a processor providing a corrected image data to the display device by referring to the crosstalk index,
wherein the crosstalk index is calculated based on an evaluation image generated by capturing an image displayed on the display device.

16. The electronic device of claim 15, wherein
the crosstalk index is calculated by reference to a center distance, and
the center distance being a distance between a center of a reference image and a center of a leaked image in the evaluation image.

17. The electronic device of claim 15, wherein the crosstalk index is calculated by selecting one of a plurality of reference images that is most similar to the evaluation image.

18. The electronic device of claim 15, wherein
the display device displays an autostereoscopic image, and
the electronic device being selected from smartphones, tablets, laptops, televisions, computer monitors, smart glasses, head-mounted displays, smart watches, and automotive electronic devices.
